(19) United States
(12) Patent Application Publication
(10) Pub. No.: US 2021/0030089 A1
(43) Pub. Date: Feb. 4, 2021

(54) Wet Suit and Composite Cloth Thereof

(71) Applicant: Lee-Chih Yeh, Zhubei City (TW)

(72) Inventor: Lee-Chih Yeh, Zhubei City (TW)

(21) Appl. No.: 16/937,774

(22) Filed: Jul. 24, 2020

(30) Foreign Application Priority Data
Jul. 31, 2019 (TW) 108127234

(51) Int. Cl. A41D 31/06; A41D 13/012; B63C 11/04

(52) U.S. Cl. CPC A41D 31/06; B63C 2011/046; B63C 11/04; A41D 13/012

(57) ABSTRACT

A wet suit includes a composite cloth which includes an outer tarpaulin, an inner tarpaulin and a plurality of heat insulation units. The inner tarpaulin is located on the inner side of the outer tarpaulin and connected to the outer tarpaulin. A plurality of heat insulation units are located between the outer tarpaulin and the inner tarpaulin.

### BACKGROUND OF THE INVENTION

### 1. Field of the Invention

The present invention relates to a wet suit and a composite cloth thereof, and more particularly to a light wet suit and composite cloth thereof with good thermal performance.

### 2. Description of the Related Art

When producing a wet suit, the textile is firstly made of polyester or polyamide fiber, and the inner layer of the textile is laminated by the elastic and heat-insulating foam material to form the composite cloth. Then, the composite cloth can be processed into a wet suit. When a diver is wearing the wet suit, the heat-insulating foam material can adhere to the body to keep the diver warm.

However, as the foam material used to make the composite cloth for conventional wet suits is quite thick and heavy, wearing a conventional wet suit may bring burden to the diver and affect the diver's strength and flexibility.

Therefore, it is necessary to provide a light wet suit with good thermal performance to overcome the above problem.

### SUMMARY OF THE INVENTION

The main object of the present invention is to provide a light wet suit with good thermal performance.

To accomplish the above object, the present invention of a wet suit includes the composite cloth, and said composite cloth includes an outer tarpaulin, an inner tarpaulin and a plurality of heat insulation units. Said inner tarpaulin is located on the inner side of said outer tarpaulin and connected to said outer tarpaulin. Said plurality of heat insulation units are located between said outer tarpaulin and said inner tarpaulin.

According to an embodiment of the present invention, wherein said composite cloth further includes a plurality of separators, said plurality of separators are located between said outer tarpaulin and said inner tarpaulin, said plurality of separators are used to form a plurality of holding spaces between said outer tarpaulin and said inner tarpaulin; said plurality of heat insulation units are respectively located inside said plurality of holding spaces.

According to an embodiment of the present invention, wherein a plurality of separators are all separating bars.

According to an embodiment of the present invention, wherein a plurality of holding spaces are formed between said separating bars of said plurality of separators, said outer tarpaulin and said inner tarpaulin.

According to an embodiment of the present invention, wherein a plurality of separators are all waterproof sheets.

According to an embodiment of the present invention, wherein said waterproof sheets of said plurality of separators are connected to said outer tarpaulin or said inner tarpaulin, to form a plurality of holding spaces.

According to an embodiment of the present invention, wherein a plurality of holding spaces are not interconnected.

According to an embodiment of the present invention, wherein a plurality of heat insulation units are made of feather, heat generating fiber, hollow fiber, aero gel, or foam.

According to an embodiment of the present invention, wherein said outer tarpaulin and said inner tarpaulin are made of rubber, silicone, waterproof film or plastic.

The main object of the present invention is to provide a kind of light composite cloth with good thermal performance.

To accomplish the above object, the present invention provides composite cloth applied in a wet suit. Said composite cloth includes an outer tarpaulin, an inner tarpaulin and a plurality of heat insulation units. Said inner tarpaulin is located on the inner side of said outer tarpaulin and connected to said outer tarpaulin. Said plurality of heat insulation units are located between said outer tarpaulin and said inner tarpaulin.

### BRIEF DESCRIPTION OF THE DRAWINGS

FIG. 1 is a schematic view of the wet suit disclosed in the first embodiment of the present invention.

FIG. 2 is a partial sectional view of the wet suit disclosed in the first embodiment of the present invention.

FIG. 3 is an exploded perspective view of the wet suit disclosed in the second embodiment of the present invention.

FIG. 4 is a schematic view of the wet suit disclosed in the second embodiment of the present invention.

### DETAILED DESCRIPTION OF THE PREFERRED EMBODIMENT

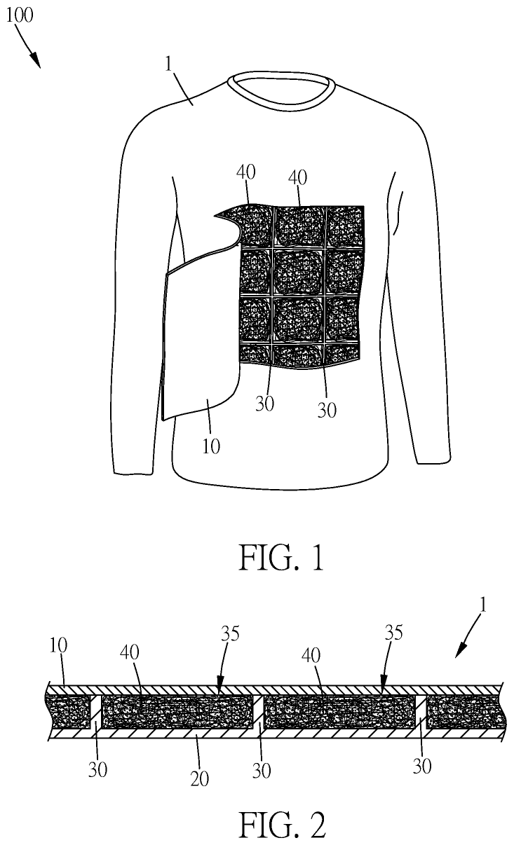

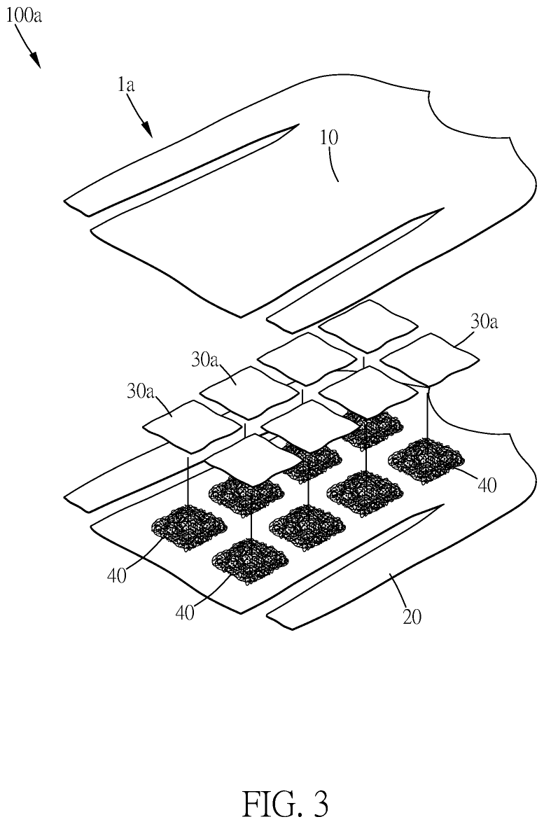

FIGS. 1 and 2 show a wet suit in the first embodiment of the present invention. FIG. 1 is a schematic view of the wet suit disclosed in the first embodiment of the present invention. FIG. 2 is a partial sectional view of the wet suit disclosed in the first embodiment of the present invention.

Referring to FIG. 1 and FIG. 2, in the first embodiment, the wet suit 100 is light-weighted and having a good thermal effect. The user can wear the wet suit 100 and move flexibly during diving, and meanwhile it can keep the user warm. The wet suit 100 includes the composite cloth 1. The composite cloth 1 is made of double-layer fabric, and including an outer tarpaulin 10, an inner tarpaulin 20, a plurality of separators 30 and a plurality of heat insulation units 40.

In the first embodiment of the present invention, the outer tarpaulin 10 and the inner tarpaulin 20 are all made of elastic waterproof materials like rubber, silicone, waterproof film or plastic. The inner tarpaulin 20 is located on the inner side of the outer tarpaulin 10 and connected to the outer tarpaulin 10, to form the inner layer and outer layer of the double-layer composite cloth 1. In the double-layer composite cloth 1, the outer tarpaulin 10 is on the side facing outward, whereas the inner tarpaulin 20 is on the side facing the body. The outer tarpaulin 10 and the inner tarpaulin 20 can prevent water from going into the space between the outer tarpaulin 10 and the inner tarpaulin 20. It is to be noted that, in the present embodiment, the double-layer composite cloth 1 is sewn in the style of a coat, but the composite cloth 1 can also be made into trousers, gloves, stocks etc. However, the outer tarpaulin 10 and the inner tarpaulin 20 may be made of different materials; for example, the outer tarpaulin 10 is rubber, whereas the inner tarpaulin 20 is silicone.

In the first embodiment of the present invention, the plurality of separators 30 are all separating bars, such as plastic bars. The plurality of separators 30 are disposed between the outer tarpaulin 10 and the inner tarpaulin 20. The separating bars of the plurality of separators 30 are used for forming a plurality of holding spaces 35 between the outer tarpaulin 10 and the inner tarpaulin 20. Each of the holding spaces 35 are blocked by the separators 30 and are not interconnected. Thus, even if the outer tarpaulin 10 or the inner tarpaulin 20 are partially damaged, causing water to go into one of the holding spaces 35, the water will stay in this holding space 35 and will not enter other holding spaces 35.

In the first embodiment of the present invention, the plurality of heat insulation units 40 are made of light and hollow heat-insulating materials such as feather, heat generating fiber, hollow fiber aero gel or foam. The plurality of heat insulation units 40 are respectively located inside the plurality of holding spaces 35. The heat-insulating effect of the heat insulation units 40 can keep the body warm. As the heat insulation units 40 are made of light hollow materials, the overall weight of the wet suit 100 can be reduced, so that the user wearing the wet suit 100 can move flexibly with little burden. Moreover, in order to resist the pressure of water during diving, the plurality of heat insulation units 40 can also be made of elastic heat generating fiber or cloth, forming a zigzag structure with a supporting force. Thus, the zigzag structure can support the holding spaces 35 to withstand the water pressure during diving, and to prevent the holding spaces 35 from being squeezed to reduce the overall size of the wet suit 100, and to further avoid excessive pressure variance during diving. Alternatively, the plurality of heat insulation units 40 can be made of mixed materials. For example, the zigzag structure with a supporting force can be made by mixing elastic heat-generating material with cloth, and filling small-size feather, aero gel or foam into the gaps of the zigzag structure, so that the heat insulation units 40 can have a good support while maintaining the heat-insulating performance.

When the user wears the wet suit 100 disclosed in the first embodiment of the present invention, the elastic inner tarpaulin 20 can adhere to the body, and the plurality of heat insulation units 40 between the outer tarpaulin 10 and the inner tarpaulin 20 can cover the body along the inner tarpaulin 20. As the heat insulation units 40 have the heat-insulating effect, the heat insulation units 40 covering the body can keep the user warm. In addition, as each of the holding spaces 35 are not interconnected, even if the outer tarpaulin 10 or inner tarpaulin 20 is partially damaged, causing water to go into one of the holding spaces 35 and resulting in diminished thermal effect of the heat insulation units 40 inside this holding space 35, the water inside this holding space 35 will not enter other holding spaces 35 to affect other heat insulation units 40. That is to say, the wet suit 100 disclosed in the present invention can still maintain good thermal performance even if it is partially damaged. Therefore, the wet suit 100 has good durability. Moreover, according to practical experiments by the inventor, if a person wearing a glove made of the composite cloth 1 puts his hand into icy water at 0° C., the hand wearing the glove made of composite cloth 1 will not feel cold at all. Thus, it can be seen that garments made of the composite cloth 1 disclosed in the present invention can have very good thermal performance.

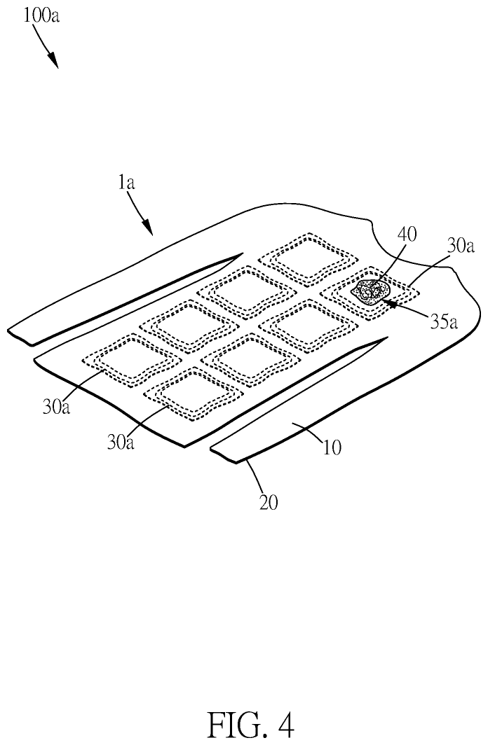

FIGS. 3 and 4 show a wet suit in the second embodiment of the present invention. FIG. 3 is an exploded perspective view of the wet suit disclosed in the second embodiment of the present invention. FIG. 4 is a schematic view of the wet suit disclosed in the second embodiment of the present invention.

Referring to FIG. 3 and FIG. 4, the difference between the second embodiment and the first embodiment is that, in the composite cloth 1a of the wet suit 100a disclosed in the second embodiment, the plurality of separators 30a are all waterproof sheets. The waterproof sheets of the plurality of separators 30a are connected to and cover the inner tarpaulin 20, forming a plurality of waterproof holding spaces 35a between the inner tarpaulin 20 and the waterproof sheets. The plurality of holding spaces 35a respectively holds the plurality of heat insulation units 40. Each of the holding spaces 35a are not interconnected. Therefore, even if any of the fabric is partially damaged, letting water into one of the holding spaces 35a and causing diminished thermal effect of the heat insulation units 40 inside this holding space 35a, the water inside this holding space 35a will not enter other holding spaces 35a to affect other heat insulation units 40. However, the plurality of separators 30a can also be configured to connect to the outer tarpaulin 10, forming a plurality of holding spaces 35a between the connected outer tarpaulin 10 and the separators 30a, to respectively house a plurality of heat insulation units 40. In addition, in the second embodiment, as a plurality of waterproof holding spaces 35a are formed between the connected tarpaulin of the separators 30a and the inner tarpaulin 20, the outer tarpaulin 10 can also be changed to other fabric without waterproof effect.

When the user wears the wet suit 100 disclosed in the second embodiment of the present invention, the elastic inner tarpaulin 20 can adhere to the body, and the plurality of heat insulation units 40 between the plurality of separators 30a and the inner tarpaulin 20 will cover the body along the inner tarpaulin 20. As the heat insulation units 40 have heat-insulating function, the heat insulation units 40 can keep the user warm.

Based on the design of the present invention of a wet suit 100, 100a with light weight and good thermal effect, the user wearing the wet suit can move flexibly during diving while maintaining warmth. In addition, even if the wet suit 100, 100a disclosed in the present invention is partially damaged to cause leakage, it can still maintain good thermal performance. Therefore, the wet suit 100, 100a has good durability.

What is claimed is:

1. A wet suit, comprising:
a composite cloth, comprising:
an outer tarpaulin;
an inner tarpaulin, located on an inner side of said outer tarpaulin and connected to said outer tarpaulin; and
a plurality of heat insulation units, located between said outer tarpaulin and said inner tarpaulin.

2. The wet suit as claimed in claim 1, wherein said composite cloth further comprising a plurality of separators, said plurality of separators being disposed between said outer tarpaulin and said inner tarpaulin, said plurality of separators being used to form a plurality of holding spaces between said outer tarpaulin and said inner tarpaulin; said plurality of heat insulation units being respectively located inside said plurality of holding spaces.

3. The wet suit as claimed in claim 2, wherein said plurality of separators are all separating bars.

4. The wet suit as claimed in claim 3, wherein a plurality of holding spaces are formed between said separating bars of said plurality of separators, said outer tarpaulin and said inner tarpaulin.

5. The wet suit as claimed in claim 1, wherein said plurality of separators are all waterproof sheets.

6. The wet suit as claimed in claim 5, wherein said waterproof sheets of said plurality of separators are connected to said outer tarpaulin or said inner tarpaulin, to form said plurality of holding spaces.

7. The wet suit as claimed in claim 4, wherein said plurality of holding spaces are not interconnected.

8. The wet suit as claimed in claim 6, wherein said plurality of holding spaces are not interconnected.

9. The wet suit as claimed in claim 1, wherein said plurality of heat insulation units are made of feather, heat generating fiber, hollow fiber, aero gel, or foam.

10. The wet suit as claimed in claim 1, wherein said outer tarpaulin and the inner tarpaulin are made of rubber, silicone, waterproof film or plastic.

11. A composite cloth, applied to a wet suit, said composite cloth comprising:
an outer tarpaulin;
an inner tarpaulin, located on an inner side of said outer tarpaulin and connected to said outer tarpaulin; and
a plurality of heat insulation units, located between said outer tarpaulin and said inner tarpaulin.

12. The composite cloth as claimed in claim 11, further comprising a plurality of separators, said plurality of separators being disposed between said outer tarpaulin and said inner tarpaulin, said plurality of separators being used to form a plurality of holding spaces between said outer tarpaulin and said inner tarpaulin; said plurality of heat insulation units being respectively located inside said plurality of holding spaces.

13. The composite cloth as claimed in claim 11, wherein said plurality of separators are all separating bars.

14. The composite cloth as claimed in claim 13, wherein a plurality of holding spaces are formed between said separating bars of said plurality of separators, said outer tarpaulin and said inner tarpaulin.

15. The composite cloth as claimed in claim 11, wherein said plurality of separators are all waterproof sheets.

16. The composite cloth as claimed in claim 15, wherein said waterproof sheets of said plurality of separators are connected to said outer tarpaulin or said inner tarpaulin, to form said plurality of holding spaces.

17. The composite cloth as claimed in claim 14, wherein said plurality of holding spaces are not interconnected.

18. The composite cloth as claimed in claim 16, wherein said plurality of holding spaces are not interconnected.

19. The composite cloth as claimed in claim 1, wherein said plurality of heat insulation units are made of feather, heat generating fiber, hollow fiber, aero gel, or foam.

20. The composite cloth as claimed in claim 11, wherein said outer tarpaulin and said inner tarpaulin are made of rubber, silicone, waterproof film or plastic.
